(19) United States
(12) Patent Application Publication
(10) Pub. No.: US 2008/0106508 A1
(43) Pub. Date: May 8, 2008

(54) METHOD OF PREVENTING IMAGE STICKING

(75) Inventor: Chien-Pang Lee, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD., Taipei (TW)

(21) Appl. No.: 11/557,949

(22) Filed: Nov. 8, 2006

(51) Int. Cl. G09G 3/36

(52) U.S. Cl. 345/89

(57) ABSTRACT

A method of preventing image sticking suitable for adjusting a static frame is described. The method of preventing image sticking includes the following steps. First, a gray level display ratio is computed. A frame is displayed by a plurality of pixel units. Each pixel unit corresponds to a gray level display ratio. Then, a difference value between the gray level display ratios of two pixel units in the static frame is computed. Next, whether the difference value is larger than a critical value is determined. When the difference value is larger than the critical value, the gray level display ratios of the two pixel units are adjusted so that the difference value is smaller the critical value.

### BACKGROUND OF THE INVENTION

1. Field of the Invention

The present invention relates to a method of preventing image sticking, and more particularly, to a method of preventing image sticking of a display frame in a liquid crystal display.

2. Description of Related Art

The rapid proliferation of multimedia techniques in our society came as a result of the great advances in semiconductor and display devices. For display devices, the many advantages including high frame quality, good special utilization, low power consumption and radiation-free operation of liquid crystal display devices have lead to their acceptance of one of the mainstream products in the market.

More specifically, liquid crystal displays are normally used to display dynamic and static frames. It should be noted that, after a static frame has been shown on a liquid crystal display for an extended period, a residual image or profile would easily stick to the display frame when another frame is displayed. This is because the liquid crystal molecules inside the liquid crystal display need to be driven by a high voltage for a prolonged period in order to display the static frame, thereby leading to an increase in the ion density of the liquid crystal. When the liquid crystal display needs to display the next frame, the driving voltage cannot accurately control the state of alignment of the liquid crystal molecules in this area because the ion density of liquid crystal in part of this area has been changed. Thus, the gray level brightness of the frame in this area of the liquid crystal display will not be the expected one. As a result, the next display frame is likely to have a darker or a brighter image profile.

If the liquid crystal display is a full color display, the color of the displayed frame may shift because of the ineffectiveness of controlling the gray level brightness. This color-shifting phenomenon will directly affect the display quality of the liquid crystal display. Hence, there is a need for improvement in this area.

### SUMMARY OF THE INVENTION

Accordingly, at least one objective of the present invention is to provide a method of preventing image sticking for correcting the problem of image sticking in a conventional liquid crystal display.

To achieve these and other advantages and in accordance with the purpose of the invention, as embodied and broadly described herein, the invention provides a method of preventing image sticking suitable for adjusting a static frame such that the static frame is displayed through a plurality of corresponding pixel units. The method of preventing image sticking includes the following steps. First, a gray level display ratio is computed. A frame is displayed by a plurality of pixel units. Each pixel unit corresponds to a gray level display ratio. Then, a difference value between the gray level display ratios of two pixel units in the static frame is computed. Next, whether the difference value is larger than a critical value is determined. When the difference value is larger than the critical value, the gray level display ratios of the two pixel units are adjusted so that the difference value will be smaller than the critical value.

In one embodiment of the present invention, the foregoing gray level display ratio is equal to the gray value of the frame that the pixel unit displays divided by the maximum gray value of the frame that the pixel unit can display.

In one embodiment of the present invention, when the foregoing difference value is greater than the critical value, the method of adjusting the gray level display ratios of the two pixel units includes: adjusting the gray level display ratios corresponding to the two pixel units to an identical constant value.

In one embodiment of the present invention, the foregoing constant value is the larger of the gray level display ratios corresponding to the two pixel units.

In one embodiment of the present invention, the foregoing constant value is the smaller of the gray level display ratios corresponding to the two pixel units.

In one embodiment of the present invention, the foregoing constant has a value 1.

In one embodiment of the present invention, the foregoing constant has a value 0.

In one embodiment of the present invention, when the foregoing difference value is greater than the critical value, the method of adjusting the gray level display ratios of the two pixel units includes: exchanging the original gray level display ratios corresponding to the two pixel units.

In one embodiment of the present invention, the foregoing two pixel units whose gray level display ratios are adjusted are adjacent to each other.

In one embodiment of the present invention, the foregoing pixel units may include red pixel units, green pixel units and blue pixel units.

In one embodiment of the present invention, the foregoing maximum gray value can be 256.

The present invention prevents image sticking by adjusting the gray level display ratios of the corresponding pixel units in the static frame so that the liquid crystal ion density in the corresponding areas of the pixel units is uniform. Thus, when the liquid crystal display shows the next frame, the arrangement of the liquid crystal molecules can be properly controlled through the driving voltage so that the image-sticking phenomenon is avoided.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing a display frame of a liquid crystal display according to the present invention.

FIG. 2 is a flow diagram showing a method of preventing image sticking according to the present invention.

FIG. 3 is a table listing the gray level display ratios corresponding to a static display frame according to the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

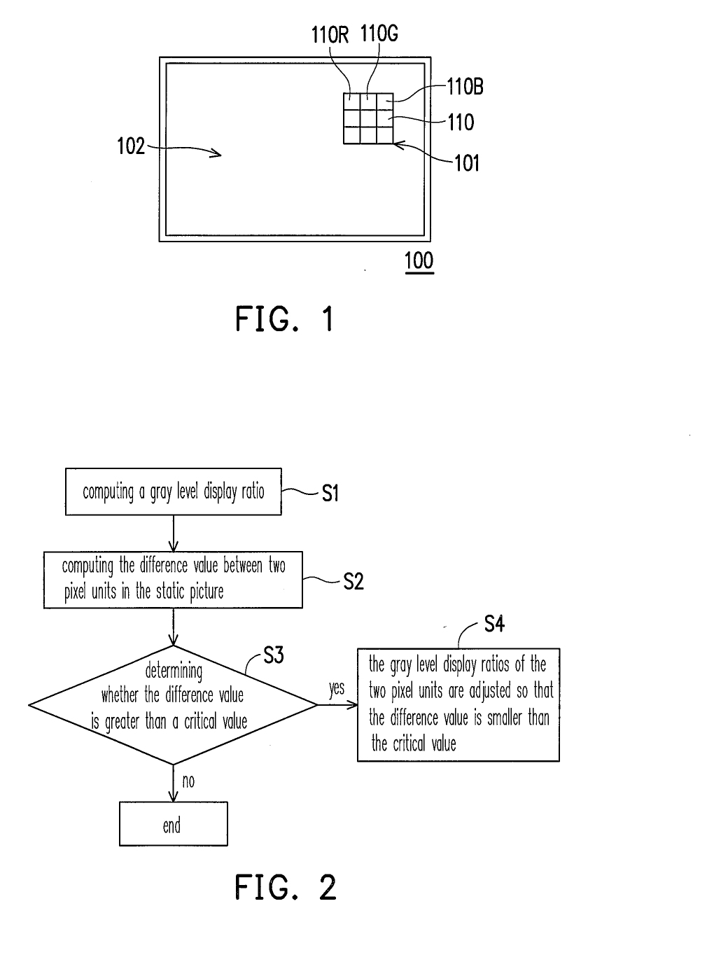

FIG. 1 is a diagram showing a display frame of a liquid crystal display according to the present invention. As shown in FIG. 1, the liquid crystal display 100 in the present invention is often used to display static frames and dynamic frames. For example, an area 101 in the liquid crystal display 100 can display a static frame while an area 102 outside the area 101 can display a dynamic frame. The static frame displayed in the area 101 can be, for example, the trademark, the channel name or the program heading of a television station. Obviously, anyone with knowledge in this field may notice that the size of the static frame in the area 101 in FIG. 1 is only used as an illustration and should not be used to limit the scope of the present invention.

In practice, the static frame may comprise a plurality of corresponding pixel units 110. To meet the requirement of a full color display, the pixel unit 110 can be a red pixel unit 110R, a green pixel unit 110G or a blue pixel unit 110B. In general, a red pixel unit 110R, a green pixel unit 110G and a blue pixel unit 110B together form a main pixel unit. By mixing the red, green and blue light emitted from the respective red pixel unit 110R, the green pixel unit 110G and the blue pixel unit 110B, the desired color is produced in the display frame.

To prevent the occurrence of image sticking phenomenon in the liquid crystal display 100 due to a prolong display of a static frame (in the area 101), a method of preventing image sticking by adjusting the static frame on the liquid crystal display 100 is provided in the present invention. FIG. 2 is a flow diagram showing a method of preventing image sticking according to the present invention. As shown in FIG. 2, step S1 is carried out to compute a gray level display ration (DR). It should be noted that the displayed frame of each pixel unit 110 corresponds to a gray level display ratio DR. The gray level display ratio DR is equal to the gray value of the frame that the pixel unit 110 displays divided by the maximum gray value of the frame that the pixel unit can display.

For example, the maximum gray value of most displayable frame is 256 and the gray value of the display frame corresponding to the red pixel unit 110R is 200. The gray level display ratio DR of the red pixel unit 110R is computed to be 0.78 (200/256=0.78). It should be noted that, under a normally white setting, the lower the gray level display ratio DR, the darker will be the display frame and the larger will be the driving voltage driving the liquid crystal molecules. Conversely, the higher the gray level display ratio DR, the brighter will be the display frame and the smaller will be the driving voltage driving the liquid crystal molecules. Obviously, anyone with general knowledge in this technical area may notice that the value in the foregoing gray level display ratio (DR) is only used as an illustration and should by no means be used to limit the scope of the present invention.

Again, as shown in FIG. 2, step S2 is carried out to compute a difference value ΔDR between the gray level display ratios DR of any two pixel units in the static frame. Then, step S3 is carried out to determine whether the difference value ΔDR is greater than a critical value L or not. It should be noted that too large a difference value ΔDR between two pixel units 110 means that the liquid crystal molecules within the area corresponding to the two pixel units 110 is driven by a larger voltage difference. If the static frame is displayed for a prolong period, the difference in the liquid crystal ion density within the areas corresponding to the two pixel units 110 may become too large and image sticking problem in the display frame may easily occur as a result. Therefore, when the difference value ΔDR of the gray value display ration DR is greater than the critical value L, step S4 is carried out to adjust the gray level display ratios DR of the two pixel units 110 so that the difference value DR is smaller than the critical value L.

Thus, by lowering the difference value ΔDR of the gray level display ratios DR of the two pixel units 110, too large a difference in the liquid crystal ion density between the areas corresponding to the two pixel units 110 can be prevented. This is an effective measure for preventing the occurrence of image sticking in the display frame. In practice, the size of the critical value L can be adjusted according to the characteristics of the liquid crystal molecules deployed. Here, it should be noted that the method of preventing image sticking in the present invention could be used to adjust the gray level display ratios of any two pixel units 110 in the static frame. The two pixel units 110 can be located within the same main pixel unit or in different main pixel units, and there is no particular restriction on this. In addition, the method of preventing image sticking in the present invention can have a number of ways for adjusting the gray level display ratios DR described in greater detail in the following.

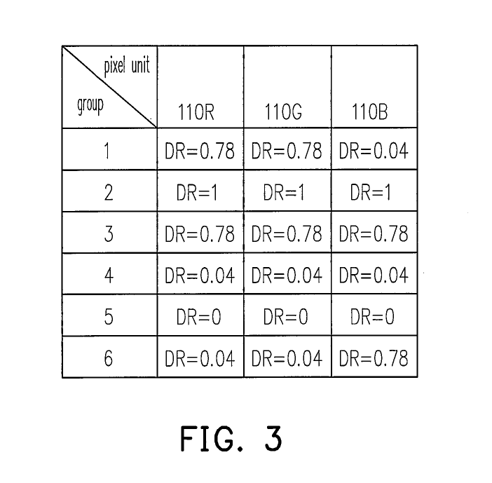

FIG. 3 is a table listing the gray level display ratios corresponding to a static display frame according to the present invention. As shown in FIGS. 1 and 3, the first group of data shows the gray level display ratios of the red pixel unit 110R, the green pixel unit 110G and the blue pixel unit 110B before any adjustment. The gray level display ratio DR of the red pixel unit 110R is 0.78, the gray level display ratio DR of the green pixel unit is 0.78 and the gray level display ratio DR of the blue pixel unit 110B is 0.04.

When the difference value ΔDR between the gray level display ration DR (0.78) of the red pixel unit 110R and the gray level display ration DR (0.04) of the blue pixel unit 110B is greater than the critical value L (for example, 0.7), the gray level display ratios can be adjusted to an identical constant value. As shown in the second group of data, the gray level display ratio of the red pixel unit 110R and the blue pixel unit 110B are adjusted to the value 1 and that of the green pixel unit 110G is also adjusted to the value 1. It should be noted that the red pixel unit 110R, the blue pixel unit 110B and the green pixel unit 110G would display the brightest frame after adjusting the gray level display ratios. In a normally white setting, this means that the liquid crystal molecules in the areas corresponding to the red pixel unit 110R, the green pixel unit 110G and the blue pixel unit 110B are prevented from being driven by too high a voltage. As a result, the liquid crystal ion density is prevented from rising too high.

Obviously, in a normally black setting, the gray level display ratio DR of the red pixel unit 110R, the green pixel unit 110G and the blue pixel unit 110B can be adjusted to the value 0. However, the gray level display ratios DR can be adjusted according to the particular setting of a liquid crystal display panel. Thus, by adjusting the gray level display ratios DR, the difference values ΔDR between the gray level display ratios DR of the red pixel unit 110R, the green pixel unit 110B and the blue pixel unit 110G are effectively reduced. Hence, the image-sticking phenomenon occurring in the display frame can be avoided.

In addition, as shown in the third group of data, the gray level display ratios DR can be adjusted to the maximum gray level display ratio DR among the original pixel units 110R, 110G and 110B. The value of the gray level display ratio of the red pixel unit 110R, the green pixel unit 110G and the blue pixel unit 110B can be adjusted to 0.78. Thus, the difference values ΔDR of the gray level display ratios are similarly reduced so that the image-sticking phenomenon occurring in the display frame can be avoided.

Obviously, the gray level display ratio DR can also be adjusted to the smallest gray level display ratio DR among the pixel units 110R, 110G and 110B. As shown in the fourth group of data, the value of the gray level display ratio of the red pixel unit 110R, the green pixel unit 110G and the blue pixel unit 110B are adjusted to 0.04. Furthermore, if the entire display frame of the liquid crystal display 100 is a static frame, then the value of the gray level display ratios of the static frame can be adjusted to 0 (as shown in the fifth group of data).

The method of adjusting the gray level display ratios DR in the present invention further includes exchanging the gray level display ratios DR corresponding to the two original pixel units 110. As shown in the sixth group of data, the gray level display ratio DR of the red pixel unit 110R is adjusted from the original value of 0.78 to 0.04 (the gray level display ratio DR of the blue pixel unit 110B in the first group of data). Similarly, the gray level display ratio DR of the blue pixel unit 110B is adjusted from the original value of 0.04 to 0.78 (the gray level display ratio DR of the red pixel unit 110R in the first group of data). Finally, the gray level display ratio DR of the green pixel unit 110G is adjusted from the original value of 0.78 to 0.04.

Thus, it means that the original voltage driving the liquid crystal molecules in areas corresponding to the red pixel unit 110R (the green pixel unit 110G) and the blue pixel unit 110B is exchanged. Therefore, the liquid crystal ion density in each pixel area is compensated toward a uniform value so that the image-sticking phenomenon occurring in the display frame can be avoided.

In summary, the method of preventing image sticking through in the present invention includes adjusting the gray level display ratios of the corresponding pixel units in the static frame so that the difference in liquid crystal ion density in the corresponding areas of the pixel units is reduced. Thus, when the liquid crystal display shows the next frame, the arrangement of the liquid crystal molecules can be properly controlled through the driving voltage so that the image-sticking phenomenon is avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of preventing image sticking suitable for adjusting a static frame, wherein the static frame is displayed through a plurality of pixel units, the method of preventing image sticking comprising:
computing a gray level display ratio, wherein the frame displayed by each pixel unit corresponds to a gray level display ratio;
computing the difference value between two pixel units in the static frame; and
determining whether the difference value is greater than a critical value, and when the difference value is greater than the critical value, the gray level display ratios of the two pixel units are adjusted so that the difference value is smaller than the critical value.

2. The method of claim 1, wherein the gray level display ratio is equal to the gray value of the frame that the pixel unit displays divided by the maximum gray value of the frame that the pixel unit can display.

3. The method of claim 1, wherein, when the difference value is greater than the critical value, the method of adjusting the gray level display ratio of two pixel units comprises:
adjusting the gray level display ratios corresponding to the two pixel units to an identical constant value.

4. The method of claim 3, wherein the constant value is the larger of the gray level display ratios corresponding to the two pixel units.

5. The method of claim 3, wherein the constant value is the smaller of the gray level display ratios corresponding to the two pixel units.

6. The method of claim 3, wherein the constant value is 1.

7. The method of claim 3, wherein the constant value is 0.

8. The method of claim 1, wherein, when the difference value is greater than the critical value, the method of adjusting the gray level display ratios of the two pixel units comprises:
exchanging the gray level display ratios corresponding to the two original pixel units.

9. The method of claim 1, wherein the gray level display ratios of the two pixel units to be adjusted are adjacent to each other.

10. The method of claim 1, wherein the pixel units comprises red pixel units, green pixel units and blue pixel units.

11. The method of claim 2, wherein the maximum gray value is 256.
